(19) United States
(12) Patent Application Publication
(10) Pub. No.: US 2005/0106278 A1
(43) Pub. Date: May 19, 2005

(54) Sheetrock corner finishing tool

(76) Inventors: David R. Hall, Provo, UT (US); Joe Fox, Spanish Fork, UT (US)

Correspondence Address: David R. Hall, 2185 S Larsen Pkwy, Provo, UT, 84606, US

(21) Appl. No.: 10/714,005

(22) Filed: Nov. 14, 2003

(51) Int. Cl. B05C 17/10

(52) U.S. Cl. 425/87

(57) ABSTRACT

A sheetrock corner finishing tool is disclosed for supplying and smoothing mastic into the corner seam of adjacent sheet rock panels. The finishing tool comprises an applicator head comprising a coupler. The coupler comprises a socket, which may comprise a seal, and a stationary member opposed to a retractable biased member. The coupler engages and disengages a mastic nozzle. The stationary member comprises a cooperating surface which may correspond to a surface of the nozzle. The biased member comprises a first cooperating surface corresponding to a surface on the nozzle and a second cooperating surface that may correspond to a surface on the nozzle. When the biased member is retracted, the respective cooperating surfaces permit engagement and disengagement of the nozzle. The cooperating surface of the stationary member and the second cooperating surface of the biased member lock the nozzle within the socket, while permitting the nozzle substantial working movement.

### RELATED APPLICATIONS

None

### BACKGROUND OF THE INVENTION

This invention relates to a sheetrock corner finishing tool used to apply and smooth mastic to the corner seam of adjacent sheetrock panels comprising an applicator head comprising a coupler. More particularly, this invention relates to a coupler located in the applicator head for connecting and disconnecting the corner finishing tool with a nozzle which is in communication with a remote source of mastic. The coupler comprises a socket for receiving the nozzle and a stationary member opposed to a retractable biased member. When the biased member is retracted, the nozzle is permitted engagement and disengagement with the socket. The nozzle and socket may also comprise a removable seal.

In the art of corner finishing tools for sheetrock, there have been two means disclosed for providing a coupler for engaging and disengaging a mastic nozzle with the tool head: the first is a generally U-shaped or generally keyhole shaped retaining spring and, more recently, the second is a keyhole shaped sliding plate.

Examples of sheetrock corner finishing tools are disclosed in the following U.S. patents.

U.S. Pat. No. 4,116,604, to Johnson et al.; U.S. Pat. No. 4,451,223, to Mower et al.; U.S. Pat. No. 5,010,618, to Croft; and U.S. Pat. No. 5,263,836, to Tinawong. These patents are incorporated herein for all that they teach and claim.

Examples of sheetrock corner finishing tools that use a retaining spring for securing a mastic nozzle in the head of the tool are found in the following U.S. Patents.

U.S. Pat. No. 3,932,101, to Johnson et al.; U.S. Pat. No. 4,767,297, to Mower et al.; and U.S. Pat. No. 6,155,809, to Edwards et al. These patents are incorporated herein by these references for all that they teach and claim.

The keyhole sliding locking mechanism is disclosed in U.S. Pat. No. 5,622,729, to Mower. This patent is incorporated herein by this reference for all that it teaches and claims.

Unlike the prior art, an object of the present invention is to provide a coupler having a socket for receiving a mastic supply nozzle that is tightly held in place by a stationary member opposed to a retractable biased member. The coupler of the present invention provides a tight connection between the mastic supply nozzle and socket preventing the escape of mastic from around the nozzle. The coupler of the present invention also allows the nozzle a wide range of working motion while captured within the socket.

Another object of the present invention is to provide a coupler having seals. The seals may be located on a surface of the socket as well as on a surface of the mastic nozzle. The seals provided herein may be removable in order to facilitate cleaning and replacement. The seals provide a further guard against leaking mastic without interfering with the range of movement required to move the tool's applicator head along the corner seam of adjoining sheetrock panels.

### SUMMARY OF THE INVENTION

A sheetrock corner finishing tool comprising a coupler is disclosed for supplying and smoothing mastic into the corner seam of adjacent sheet rock panels. The finishing tool comprises an applicator head comprising the coupler which comprises a socket which may comprise a seal, a stationary member opposed to a biased member, and a detachable mastic nozzle, which also may comprise a seal. The respective seals are preferably removable in order to facilitate replacement and cleaning. The detachable nozzle is used to deliver pressurized mastic to the seam of the sheetrock panels.

The detachable mastic nozzle, which is in communication with a remote source of mastic, comprises an exterior surface that substantially corresponds with the shape of an interior surface in the socket. Normally, the mastic is supplied under pressure. As the mastic flows under pressure through the nozzle and is applied by the applicator head to the seam of the sheet rock panels, the respective corresponding surfaces of the nozzle and of the socket fit tightly together in order to prevent leakage of the mastic from around the nozzle.

The coupler further comprises a stationary member opposed to a retractable biased member. The stationary member and the retractable biased member comprise cooperating surfaces that serve to hold the nozzle in place. The stationary member's cooperating surface may at least in part correspond to the surface of the nozzle. The retractable biased member comprises a first cooperating surface that may at least in part correspond to the surface of the nozzle, and a second cooperating surface that, also, may at least in part correspond to the surface of the nozzle. When the biased member is retracted the respective cooperating surfaces permit engagement and disengagement of the nozzle with the socket. Further, the respective cooperating surfaces of the coupler serve to lock the nozzle within the socket, while, at the same time, permitting the nozzle substantial angular, vertical, and rotational working movement, as the tool is moved along the corner seam.

The socket is replaceable to facilitate cleaning and replacement and so that it may receive different nozzle configurations depending on the application of the tool. An interior surface of the socket substantially corresponds with an exterior surface of the nozzle so that when engaged, the respective surfaces are in close proximity of each other in order to prevent leakage of the mastic. The socket and the nozzle may at least be partially hemispherical, conical, or prismatic in shape. The respective corresponding surfaces permit a broad range of working motion for the mastic nozzle while it is being moved along the seam of the sheetrock panels.

To further prevent leakage of the mastic, the mastic nozzle and the socket may be provided with seals. Since the mastic may have some abrasive properties, it is preferable that the seal be easily removed for cleaning and replacement. The seal may be composed of any suitable material such as steel, copper, bronze, brass, rubber, nylon, Teflon, or some other metallic or polymeric material suitable for resisting the chemical and abrasive properties of the mastic.

In operation, the retractable biased member is manually retracted by an operator of the tool. The biased member uses a compression spring or a torsional spring to return the member to its biased, or closed, locking position. In some embodiments, the biased member may be retracted vertically, while in others it may be retracted angularly. In still other embodiments, the biased member will be retracted rotationally. When retracted, the first cooperating surface of the member provides clearance to engage and disengage the nozzle in the socket. When closed, the second cooperating surface, of the biased member, serves to lock the nozzle in place. Tight engagement of the nozzle in the socket is preferred in order to discourage leaking of the mastic from around the nozzle.

The cooperating surface of the coupler's stationary member may not have a surface that corresponds to the surface of the nozzle. However, it is essential that the cooperating surface of the stationary member be sufficient to rigidly contact the surface of the nozzle. For ease of manufacture, the cooperating surface may not correspond to the surface of the coupler, however, since a function of the stationary member is to hold the nozzle in tight engagement with the socket, it may be desirable in to increase the surface contact between the stationary member and the nozzle. This may be achieved by providing a cooperating surface that substantially corresponds with a surface of the nozzle. Another advantage of having a matching interface between the stationary member and the nozzle is to promote smooth movement and a wide range of motion of the nozzle within the socket during operation.

The invention will be further described in reference to the following drawing figures wherein like elements are number similarly.

### BRIEF DESCRIPTION OF THE DRAWINGS

FIG. 1 is a perspective diagram of the present invention depicting the applicator head and an embodiment of the socket and the coupler comprising a vertically biased member.

FIG. 2 is a perspective diagram of the present invention depicting an embodiment of the socket comprising a seal.

FIG. 3 is a perspective diagram of the present invention depicting an embodiment of the nozzle comprising a seal.

FIG. 4 is a perspective diagram of the present invention as shown in FIG. 1 depicting an embodiment of the socket comprising a seal.

FIG. 5 is a perspective diagram of the present invention as shown in FIG. 1 depicting an embodiment of the nozzle locked within the socket by the stationary and biased members of the coupler.

FIG. 6 is a perspective diagram of an embodiment of the coupler of the present invention comprising a rotationally biased member.

FIG. 6a is a perspective diagram of the embodiment of the coupler shown in FIG. 6 in the rotationally retracted position.

FIG. 7 is a perspective diagram of an embodiment of the coupler of the present invention comprising an angularly biased member.

FIG. 7a is a perspective diagram of the embodiment of the coupler shown in FIG. 7 in the angularly retracted position.

FIG. 8 is a perspective diagram of an embodiment of the present invention depicting a prismatic socket and a coupler having a rotationally biased member.

FIG. 8a is a perspective diagram of the embodiment of the present invention as shown in FIG. 8 with the coupler in the angularly retracted position.

### DETAILED DESCRIPTION OF THE INVENTION

A sheetrock corner finishing tool is disclosed for supplying and smoothing mastic into the corner seam of adjacent sheet rock panels. The finishing tool comprises an applicator head comprising a coupler. The coupler comprises a socket which may comprise a seal, and a stationary member opposed to a retractable biased member. The coupler serves to engage and disengage a mastic nozzle which is in communication with a remote source of mastic. The stationary member comprises a cooperating surface that may correspond to a surface of the nozzle, while the biased member comprises a first cooperating surface that may correspond to a surface of the nozzle and a second cooperating surface that may not correspond to a surface of the nozzle. When the biased member is retracted, the respective cooperating surfaces permit engagement and disengagement of the nozzle with the socket. The cooperating surface of the stationary member and the second cooperating surface of the biased member cooperate to lock the nozzle within the socket, while permitting the nozzle substantial working movement.

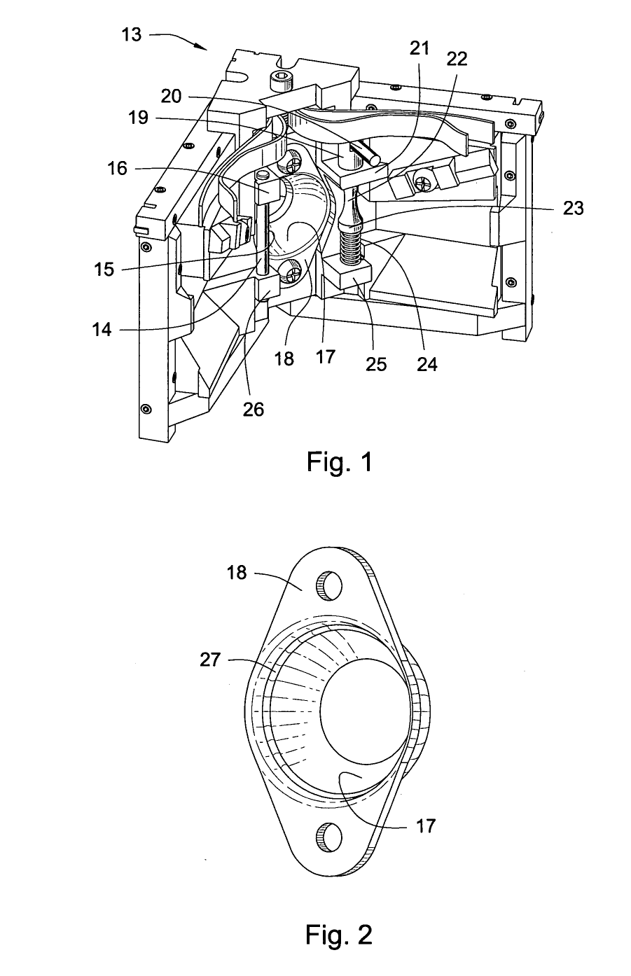

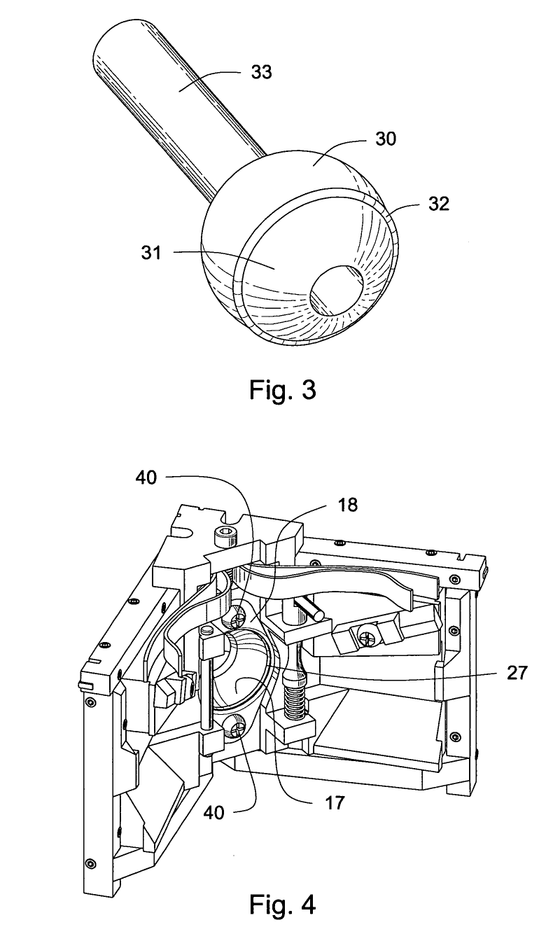

FIG. 1 is a perspective diagram of the present invention depicting the applicator head 13 and the coupler comprising an embodiment of the socket 18, the stationary member 14 opposed to the vertically biased member 19. Stationary member 14 comprises a cooperating surface 15. Cooperating surface 15 may comprise a corresponding surface, not shown, that corresponds with surface 31 of the mastic nozzle 30 as shown in FIG. 3. The stationary member 14 is fixed in place at flanges 16 and 26. The stationary member 14 is fixed within the flanges 16 and 26 by any suitable means such as by an adhesive, by a press fit, by threads, or by a set screw not shown.

The socket 18 comprises a corresponding surface 17 that matches a corresponding surface 31 of the nozzle 30, as shown in FIG. 3. The socket 18 is detachable in order to facilitate cleaning and replacement. Socket 18 may also comprise a seal 27, as shown in FIG. 2. It is preferred that the seal be removable in order to facilitate cleaning and replacement. As mastic is delivered under pressure from the remote source through the nozzle, leakage may occur around the nozzle along the corresponding surfaces 17 and 31. A tight fit between corresponding surfaces 17 and 31 may prevent the leakage, but as an extra precaution, seal 27, of FIG. 2, and seal 32, of FIG. 3 are provided to prevent further leakage.

Retractable biased member 19 is disposed in the coupler in opposition to stationary member 14. Retractable biased member 19 comprises an actuator 20, a first cooperating surface 22, and a second cooperating surface 23. The cooperating surfaces 15, 22, and 23 may substantially correspond with surface 31 on nozzle 30. Member 19 further comprises a compression spring 25 to vertically bias member 19 in the closed, or locked, position. Member 19 is movably fixed in position by flanges 21 and 25 which may comprise means such as a shoulder or a snap ring, not shown, to retain member 19 in its opposed position relative to stationary member 14 and yet permit vertical movement of member 19 to engage and disengage a mastic nozzle as shown in FIG. 3.

Retractable biased member 19 further comprises a second cooperating surface 23, which may comprise a surface corresponding to a surface on the nozzle. As depicted in FIG. 1, second cooperating surface 23 does not comprise a corresponding surface. It may be preferable for second cooperating surface 23 to comprise a cooperating surface that corresponds with a surface on the nozzle in order to achieve a more secure lock and at the same time facilitate angular, vertical, and rotational movement of the nozzle during operation.

Member 19 is biased in the closed or locked position, with first cooperating surface 22 comprising a surface that substantially corresponds with a surface on nozzle 30. Actuator 20 is used to move member 19 vertically into the retracted, or open, position thereby providing clearance for engagement and disengagement of nozzle 30.

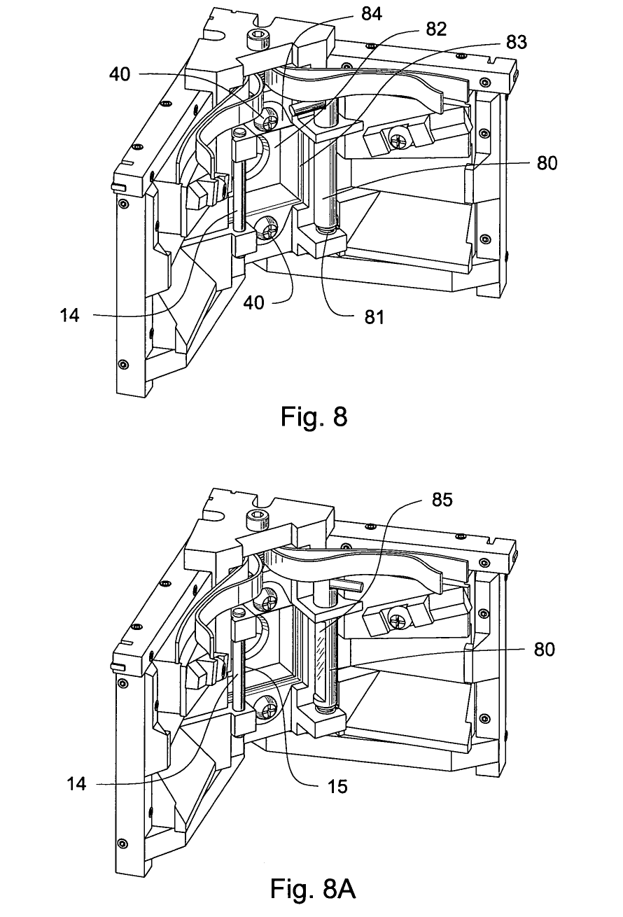

FIG. 2 is a perspective diagram of the present invention depicting an embodiment of the socket 18 comprising an interior corresponding surface 17 having a hemispherical or conical shape and further comprising a seal 27. The shape of the interior surface of the socket may vary according to the exterior shape of the surface of the nozzle to be attached to it. For example, FIG. 8 depicts a socket 84 comprising a prismatic interior surface 82. Although, the corresponding surface 17 matches closely surface 31 of nozzle 30 in order to prevent leakage of the mastic, a seal 27 is desirable as a further barrier to leakage. The seal may be composed of any suitable material such as steel, copper, bronze, brass, rubber, nylon, Teflon, or some other metallic or polymeric material suitable for resisting the chemical and abrasive properties of the mastic. It is preferred that both the seal and the socket be removable in order to facilitate cleaning and replacement.

FIG. 3 is a perspective diagram of the present invention depicting an embodiment of the nozzle 30 comprising a corresponding surface 31 and comprising a seal 32. The nozzle 30 further comprises a means 33 for communicating with a remote source of mastic.

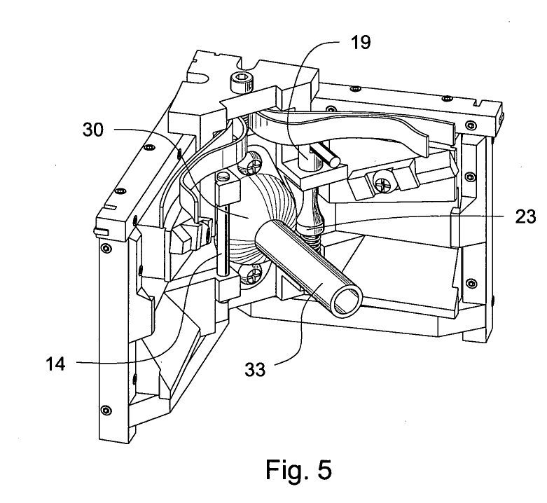

FIG. 4 is a perspective diagram of the present invention as shown in FIG. 1 depicting an embodiment of the socket 18 made removable by means of screws 40 and comprising corresponding surface 17 and seal 27. FIG. 5 is a perspective diagram of the present invention as shown in FIG. 1 depicting an embodiment of the nozzle 30 locked within the socket 18 by means of cooperation of the stationary member 14 and retractable biased member 19 of the coupler. Member 19 is shown in the locked position whereby the second cooperating surface 23 contacts a surface on the nozzle 30 and locks the nozzle 30 into the socket 18.

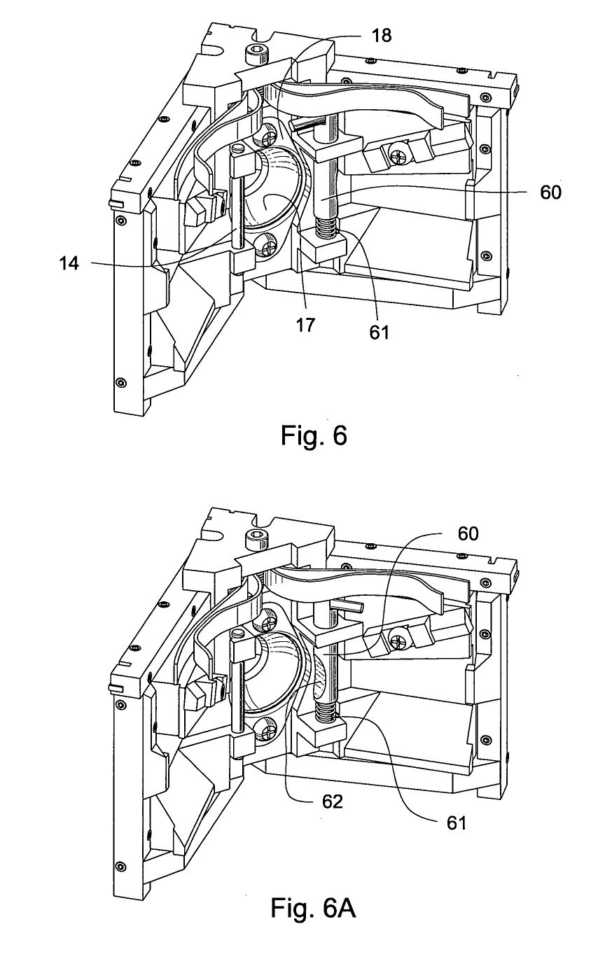

FIG. 6 is a perspective diagram of an embodiment of the coupler of the present invention comprising a stationary member 14 opposed to a rotationally biased member 60. A torsional spring 61 is provided to bias member 60 in the closed position. As in prior embodiments, stationary member 14 and retractable biased member 60 may further comprise corresponding surfaces to aid in the retention of nozzle 30 within socket 18. FIG. 6a is a perspective diagram of the embodiment of the coupler shown in FIG. 6 in the rotationally retracted position. Retractable member 60 is actuated rotationally to expose cooperating surface 62, here depicted as a corresponding surface, to the surface of nozzle 30. Cooperating surface 62 provides clearance for engaging and disengaging nozzle 30. Torsional spring 61 supplies sufficient torque to retractable member 60 to return it to the closed position once nozzle 30 is engaged.

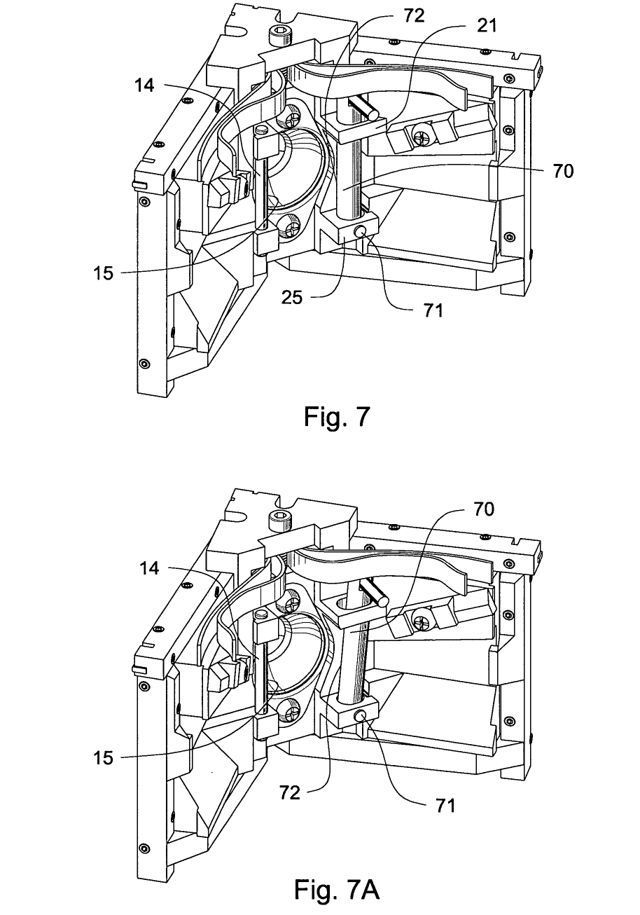

FIG. 7 is a perspective diagram of an embodiment of the coupler of the present invention comprising a stationary member 14 comprising a cooperating surface 15 opposed to angularly biased member 70 comprising a cooperating surface 72. Cooperating surfaces 15 and 72 are not corresponding surfaces. A pivot pin 71 in flange 25 provides an axis on which biased member 70 rotates. A compression spring, not shown, located within flange 21 serves to bias retractable member 70 in the closed, or locked, position, as shown herein. FIG. 7a is a perspective diagram of the embodiment of the coupler shown in FIG. 7 depicting biased member 70 in the angularly retracted position. In this position, cooperating surfaces 15 and 72 provide clearance for engagement and disengagement of nozzle 30.

FIG. 8 is a perspective diagram of an embodiment of the present invention depicting a coupler comprising a socket 84 comprising a prismatic interior surface 82 having a seal 83. The socket 84 is made detachable by means of screws 40. The coupler further comprises stationary member 14, comprising cooperating surface 15, and a rotationally biased member 80 further comprising a torsional spring 81. FIG. 8a is a perspective diagram of the embodiment of the present invention as shown in FIG. 8 with the angularly retractable member 80 in the retracted position so that it exposes cooperating surface 85, shown here as a corresponding surface, to the opposed cooperating surface 15 of the stationary member 14. The cooperating surfaces 15 and 85 provide the clearance required to engage and disengage a prismatic nozzle not shown.

1. A sheetrock corner finishing tool, comprising:
an applicator head comprising a socket;
a detachable nozzle;
a coupler comprising a stationary member opposed to a retractable biased member, the biased member comprising a cooperating surface;
wherein when the biased member is retracted the cooperating surface cooperates with the stationary member to permit engagement and disengagement of the nozzle with the socket.

2. The sheet rock corner finishing tool of claim 1, wherein the cooperating surface of the retractable biased member corresponds to an exterior surface of the nozzle.

3. The sheet rock corner finishing tool of claim 1, wherein the retractable biased member comprises a surface that does not correspond to an exterior surface of the nozzle.

4. The sheet rock corner finishing tool of claim 1, wherein the stationary member comprises a surface that does not correspond to an exterior surface of the nozzle.

5. The sheet rock corner finishing tool of claim 1, wherein the biased member comprises a compression spring.

6. The sheet rock corner finishing tool of claim 1, wherein the biased member comprises a torsional spring.

7. The sheet rock corner finishing tool of claim 1, wherein the biased member retracts vertically.

8. The sheet rock corner finishing tool of claim 1, wherein the biased member retracts angularly.

9. The sheet rock corner finishing tool of claim 1, wherein the biased member retracts rotationally.

10. The sheet rock corner finishing tool of claim 1, wherein the surfaces, of the stationary and the retractable biased members, that do not correspond with the exterior surface of the nozzle cooperate to lock the nozzle in the socket.

11. The sheet rock corner finishing tool of claim 1, wherein the nozzle is locked in substantially sealed engagement with the socket.

12. The sheet rock corner finishing tool of claim 1, wherein an interior surface of the socket corresponds with an exterior surface of the nozzle.

13. The sheet rock corner finishing tool of claim 1, wherein an interior surface of the socket and an exterior surface of the nozzle are substantially hemispherical.

14. The sheet rock corner finishing tool of claim 1, wherein an interior surface of the socket and an exterior surface of the nozzle are substantially conical.

15. The sheet rock corner finishing tool of claim 1, wherein an interior surface of the socket and an exterior surface of the nozzle are substantially prismatic.

16. The sheet rock corner finishing tool of claim 1, wherein the corresponding surfaces of the nozzle and the socket and the non-corresponding surfaces of the stationary member and the retractable biased member allow vertical, lateral, and rotational movement of the nozzle while it is engaged in the socket.

17. The sheet rock corner finishing tool of claim 1, wherein the nozzle is in communication with a remote source of mastic.

18. A sheetrock corner finishing tool, comprising:
an applicator head comprising a socket comprising a seal;
a detachable nozzle;
a coupler comprising a stationary member opposed to a retractable biased member, the biased member comprising a cooperating surface;
wherein when the biased member is retracted the cooperating surface cooperates with the stationary member to permit locked engagement and disengagement of the nozzle with the socket.

19. A sheetrock corner finishing tool, comprising:
an applicator head comprising a socket;
a detachable nozzle comprising a seal;
a coupler comprising a stationary member opposed to a retractable biased member, the biased member comprising a cooperating surface;
wherein when the biased member is retracted the cooperating surface cooperates with the stationary member to permit engagement and disengagement of the nozzle with the socket.

20. A sheetrock corner finishing tool, comprising:
an applicator head comprising a socket comprising a seal;
a detachable nozzle comprising a seal;
a coupler comprising a stationary member opposed to a retractable biased member, the biased member comprising a cooperating surface;
wherein when the biased member is retracted the cooperating surface cooperates with the stationary member to permit engagement and disengagement of the nozzle with the socket.

21. The sheetrock corner finishing tool of claims 18, 19, and 20, wherein the seal is removable.
